(19) United States
(12) Patent Application Publication
(10) Pub. No.: US 2014/0052540 A1
(43) Pub. Date: Feb. 20, 2014

(54) PROVIDING CONTENT USING INFERRED TOPICS EXTRACTED FROM COMMUNICATIONS IN A SOCIAL NETWORKING SYSTEM

(71) Applicants: Giridhar Rajaram, Cupertino, CA (US); Gang Wu, San Jose, CA (US); Hong Yan, Mountain View, CA (US); Jeff Kanter, San Francisco, CA (US)

(72) Inventors: Giridhar Rajaram, Cupertino, CA (US); Gang Wu, San Jose, CA (US); Hong Yan, Mountain View, CA (US); Jeff Kanter, San Francisco, CA (US)

(21) Appl. No.: 13/589,693

(22) Filed: Aug. 20, 2012

(51) Int. Cl. G06Q 30/02

(52) U.S. Cl. 705/14.66

(57) ABSTRACT

A social networking system may infer interests based on extracted topics from content items on the social networking system. A user's comments and page likes in a social networking system are used to infer topics in which the user is interested. Topics may also be automatically extracted from users' posts, and the extracted topics may be generalized using a category tree to identify additional topics for the user. The social networking system may target content such as advertisements to users based on these extracted topics. For example, the social networking system may boost stories related to the extracted topics in the user's content feeds, append stories about the extracted topics to advertisements that are also related to the topics, append advertisements to stories about the extracted topics, or use the extracted topics as targeting criteria for an advertisement.

### BACKGROUND

This invention relates generally to social networking, and in particular to inferring users' interests based on topics extracted from content items in a social networking system and providing content to the users based on the users' inferred interests.

Traditional advertisers relied on massive lists of keywords to target audiences based on their interests. For example, a sports drink advertiser may target audiences that are interested in sports, such as baseball, basketball, and football, among others. However, advertisements may be presented in locations and at times where the audiences are not actively engaging in an activity related to the product. This leads to wasted ad spending because audiences may not pay attention to the advertisement for lack of relevance.

In recent years, social networking systems have made it easier for users to share their interests and preferences in real-world concepts, such as their favorite movies, musicians, celebrities, brands, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Although advertisers may have some success in targeting users based on interests and demographics, tools have not been developed to target users based on their current user activity on the social networking system.

Specifically, users may generate and engage with different content items that describe differing topics in a social networking system. These users have not been targeted by a social networking system based on their engagement with these content items. A social networking system may have millions of users that have varying interests in a multitude of topics, such as movies, songs, celebrities, brands, sports teams, and the like. However, existing systems have not provided efficient mechanisms of inferring interests based on extracted topics.

### SUMMARY

A social networking system may infer interests based on extracted topics from content items on the social networking system. A user's comments and page likes in a social networking system are used to infer topics in which the user is interested. Topics may also be automatically extracted from users' posts, and the extracted topics may be generalized using a category tree to identify additional topics for the user. The social networking system may target content such as advertisements to users based on these extracted topics. For example, the social networking system may boost stories related to the extracted topics in the user's content feeds, append stories about the extracted topics to advertisements that are also related to the topics, append advertisements to stories about the extracted topics, or use the extracted topics as targeting criteria for an advertisement.

### BRIEF DESCRIPTION OF THE DRAWINGS

FIG. 1 is high level block diagram illustrating a process of inferring interests based on topics extracted from content items in a social networking system, in accordance with an embodiment of the invention.

FIG. 2 is a network diagram of a system for inferring interests based on topics extracted from content items in a social networking system, showing a block diagram of the social networking system, in accordance with an embodiment of the invention.

FIG. 3 is high level block diagram illustrating an topic inference module that includes various modules for inferring interests based on topics extracted from content items in a social networking system, in accordance with an embodiment of the invention.

FIG. 4 is a flowchart of a process of targeting advertisements to users of a social networking system based on extracted topics from content items in the social networking system, in accordance with an embodiment of the invention.

FIG. 5 is a flowchart of a process of associating one or more generalized topics with a node in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340, filed on Sep. 21, 2011, which is hereby incorporated by reference.

Advertisers may engage with users of a social networking system through different communication channels, including direct advertisements, such as banner ads, indirect advertisements, such as sponsored stories, generating a fan base for a page on the social networking system, and developing applications that users may install on the social networking system. An advertiser benefits from identifying users based on topic associations related to the advertiser's product, brand, application, as well as other concepts and objects on the social networking system because advertisers may more effectively target their advertisements, providing different advertisements based on the topic associations. In turn, a social networking system benefits from increased advertising revenue by enabling advertisers to target users based on topic associations for objects because the social networking system may modify bid prices for users based on their topic associations.

A social networking system may receive targeting criteria for an advertisement from an advertiser that includes a specific selected topic, in one embodiment. For example, an advertiser may wish to target users that have an interest in a particular celebrity such as Britney Spears, a recent movie release for Ted, or the playoff race for the 2012 Major League Baseball World Series. Users of the social networking system may generate and interact with various content items on the social networking system, such as a user submitting an RSVP to an event object for a Britney Spears concert, a status update mentioning the new Ted movie by a user, a check-in event at AT&T Park, and the like. Targeting criteria may be defined to include users that have expressed a specific interest in a topic, in one embodiment. In another embodiment, a topic may be specified by an advertiser in the targeting criteria. As a result, a social networking system may distribute topical ads to users based on determining that extracted topics from content items are relevant to a selected topic included in the targeting criteria. Users may receive topical ads in the form of sponsored stories that are boosted as a result of being relevant to the selected topic, appending ads to stories about the selected topic, social advertisements about the selected topic, and traditional targeting of advertisements using the selected topic.

In yet another embodiment, a social networking system may infer interests of users and/or pages of the social networking system based on the extracted topics of content items interacted with or generated by the users and/or pages. As mentioned above, nodes of the social networking system may include users as well as entities that are represented as pages on the social networking system. For example, pages titled “Starbucks USA,” “Starbucks EU,” and “Starbucks.com” may be about a particular topic, “Starbucks Coffee.” Though the page for Starbucks USA may not have an “interest” in the same manner as a user may have an interest in Starbucks Coffee, the page is affiliated or associated with the particular topic of Starbucks Coffee. Users may also be affiliated or associated with the particular topic of Starbucks Coffee based on content items that they have generated and their interactions with pages affiliated with Starbucks Coffee, such as check-in events at Starbucks Coffee locations, page likes, page comments, and so forth.

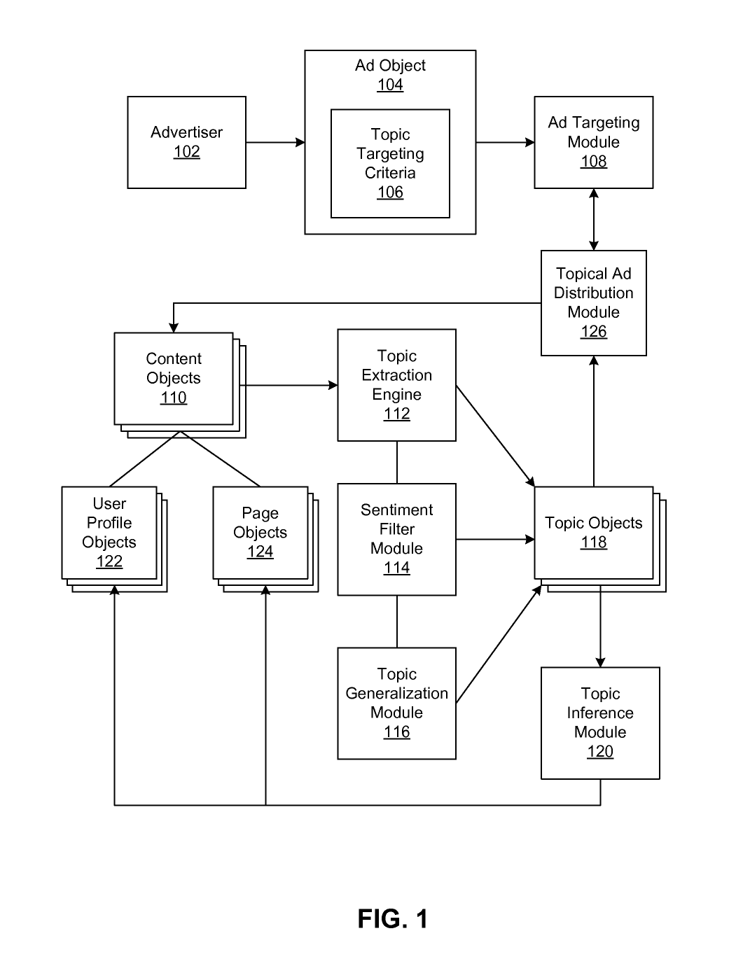

FIG. 1 illustrates a high level block diagram of a process of inferring interests based on topics extracted from content items in a social networking system, in one embodiment. A social networking system 100 includes an advertiser 102 that provides an ad object 104 that includes topic targeting criteria 106 to the social networking system 100. The topic targeting criteria 106 may include any type of topic, concept, or interest, such as a general interest in technology, inferred by the social networking system 100 in response to a user viewing an article about Steve Jobs, a more specific interest in pop music, inferred by the social networking system 100 in response to a user sharing a link to a page dedicated to Justin Bieber, installing an application for a music streaming service, and listening to over a hundred pop songs over a week. The social networking system 100 may enable the topic targeting criteria 106 to be as specific or as broad as selected by the advertiser 102. In another embodiment, categories of interests, such as broad category interests like jogging, running, yoga, and music, as well as interests that may be unified by a common theme, such as teen pop stars (including interests in Britney Spears, Lady Gaga, and Justin Bieber), may also be defined in the topic targeting criteria 106.

Content objects 110 represent content items generated in the social networking system 100, including status updates associated with photos, locations, and users, photos associated with other objects such as events, pages, and other users, and applications installed on the social networking system 100 that generate further content items such as posts, stories, advertisements, and the like. Content objects 110 may be generated in the social networking system 100 by users represented by user profile objects 122 and entities, represented by pages, further represented by page objects 124. Content objects 110 may be analyzed by a topic extraction engine 112 that determines one or more topics to be extracted from each content object 110. Extracting topics from content items on a social networking system is further described in a related application, “Inferring Topics from Status Updates of Users in a Social Networking System,” U.S. patent application Ser. No. 13/167,701, filed on Jun. 24, 2011, hereby incorporated by reference.

A sentiment filter module 114 may be used to ensure that the extracted topic from the content objects 110 is being expressed in a positive sentiment, as opposed to a negative sentiment. For example, a status update that reads “Magic Mike was awesome!” has a positive sentiment about the movie “Magic Mike” that may indicate an interest by the user in that topic. However, the sentiment filter module 114 may identify negative sentiment by filtering content objects 110 that included blacklisted keywords, profanity, and content generated by blacklisted users, for example. The sentiment filter module 114 generates topic objects 118 that have been identified as satisfying the positive sentiment requirements determined by the advertisers and/or administrators of the social networking system 100. In one embodiment, the sentiment filter module 114 disassociates topic objects 118 from content objects 110 that were associated based on the topic extraction engine 112 where the disassociated topic objects 118 were included in the content objects 110 with a negative sentiment.

A topic generalization module 116 may also be used to generate additional topics that may be extracted from content objects 110. Using category trees, for example, an extracted topic may be generalized to produce additional topics. For example, a photo upload with a caption of “My Mini Cooper” may result in an extracted topic of “Mini Cooper” by the topic extraction engine 112. Using category trees, other topics may be generalized from “Mini Cooper,” including “car” and “British.” A “car” category tree may include several branches, including “Toyota,” “Prius,” “Mini,” “Mini Cooper,” and so on. As a result, an advertisement that targets posts about a “car” may also hit posts about “Toyota,” “Prius,” “Mini,” “Mini Cooper,” and other branches under the “car” category tree. Similarly, a “British” category tree may have different branches, such as “Olympics,” “London,” and “Big Ben.” Content items about the topics of the branches (Olympics, London, and Big Ben) may also be targeted by an advertisement for British Airways, for example, that targets “British” topics. Other data structures, such as dictionaries, databases, and quick lookup tables, may also be used in generalizing topics based on extracted topics.

Topics may be represented in the social networking system 100 as topic objects 118. Topics extracted from content objects 110 are represented as topic objects 118. An extracted topic represented by a topic object 118 is associated with the content object 110 that represents the content item from which the topic was extracted. Similarly, generalized topics based on extracted topics may be represented by topic objects 118 and may be associated with content objects 110 based on the extracted topics.

A topical ad distribution module 126 may receive topic objects 118 that have been extracted from content objects 110 through the topic extraction engine 112, the sentiment filter 114, and/or the topic generalization module 116. An ad targeting module 108 may access the received topic objects 118 from the topical ad distribution module 126 for targeting advertisements to content objects 110 about the extracted topic objects 118. In one embodiment, the topical ad distribution module 126 may provide topical ads for display to users of the social networking system 100. The topical ads may be appended directly to the content items, or stories, about the targeted topics, in one embodiment. In another embodiment, the topical ads may be displayed on the same page or application displaying communication channels of the social networking system 100, such as the news feed, messaging platforms, mobile applications, and so forth. In yet another embodiment, the topical ads may be distributed by the topical ad distribution module 126 as sponsored stories, such that user-generated content items about the targeted topics are boosted in the communication channels of the social networking system 100. In a further embodiment, social advertisements that aggregate content items about targeted topics may be distributed by the topical ad distribution module 126.

The ad object 104 having the topic targeting criteria 106 is received by the ad targeting module 108. The ad targeting module 108 receives information about users from user profile objects 122, content objects 110, and page objects 124. User profile objects 122 include declarative profile information about users of the social networking system 100. Content objects 110 may include objects on the social networking system 100 that represent status updates, messages, comments, videos, photos, applications, and custom graph objects defined by third party developers. Page objects 124 include information about a page on the social networking system 100, such as properties of the page, a listing of users currently viewing the page, and content objects 110.

A topic inference module 120 analyzes the topic objects 118 extracted from content objects 110 by the topic extraction engine 112 for association with user profile objects 122 and page objects 124. In one embodiment, the topic inference module 120 may determine that a particular topic object 118 should be associated with a user or a page based on the number and frequency of comments and status updates mentioning the topic represented by the topic object 118. The topic inference module 120 may also identify pages that may be associated with a topic object 118 based on comments and posts by users of the social networking system 100 associated with the pages. In one embodiment, topic objects 118 may be selected and inferred by the topic inference module 120 based on analyzing user profile objects 122 and page objects 124. For example, a user who has expressed favorable opinions for Starbucks Coffee and for the Home and Garden Television Network (HGTV) through posting links having those keywords, posting status updates, creating check-in events, accepting special offers, logging into applications associated with those brands, and generating other actions on objects associated with the brands. As a result, the user may be inferred to have interests in the topics of “Starbucks Coffee” and “HGTV,” which may then be used by an advertiser for targeting ads about a new espresso coffee machine to the user. Machine learning algorithms may be used in generating these inferences based on the information received about users of the social networking system 100.

In one embodiment, affinity scores of users for the specified object may be determined by the social networking system 100 based on interactions with the specified object over time. The affinity scores of users may be computed for various objects based on actions performed on those objects, such as sharing a link to the object, commenting on the object, installing the object, and the like, as further described in a related application, “Contextually Relevant Affinity Prediction in a Social Networking System,” U.S. Patent Application No. 12/978,265, filed on Dec. 23, 2010, which is hereby incorporated by reference. In another embodiment, a user may be currently viewing a page or may have just posted a comment mentioning a particular topic. An advertiser 102 may specifically include in topic targeting criteria 106 for an ad object 104 that the advertisement should be dynamically targeted to that user viewing a specified page or completing an action that mentions the particular topic, in real-time. In this way, the advertiser 102 may have to pay a high price for targeting that user based on the contextual signals, but the predicted click-through rate (CTR) of the advertisement may be higher as a result.

A social networking system 100 implements a bid auction system for providing advertisements to users of the social networking system. As a publisher of the advertisements, the social networking system 100 may charge higher cost-per-click (CPC) prices for users based information relevant to the likelihood that users will click on the advertisement, such as this real-time information about interest in an object, or other topic information about users determined by the social networking system 100. Timelier, and therefore more relevant, advertisements may have higher bid prices for users that have recently performed an action on an object specified in the topic targeting criteria 106 as well as users that have been associated with a topic object 118 by the topic inference module 120.

An ad targeting module 108 receives targeting information from the topical ad distribution module 126 for providing the advertisement embodied in the ad object 104 to users of the social networking system 100. The topical ad distribution module 126 may include in the targeting information placement information of the advertisement, such as being attached to content objects 110 associated with relevant topic objects 118, content objects 110 associated with page objects 124 that have been associated with relevant topic objects 118, notifications associated with relevant topic objects 118, and so forth. The advertisement may be provided to users of the social networking system 100 through multiple communication channels, including mobile devices executing native applications, text messages to mobile devices, websites hosted on systems external to the social networking system 100, and ad delivery mechanisms available on the social networking system 100, such as sponsored stories, banner advertisements, and page posts. As content objects 110 associated with the relevant topic objects 118 included in the topic targeting criteria 106 are generated in and external to the social networking system 100, the ad object 104 may be provided to the viewing users for display by the ad targeting module 108 based on the targeting information received by the topical ad distribution module 126.

A user of the social networking system 100 may opt out of having topics extracted from content objects 110 that the user has interacted with, generated, and/or shared on the social networking system 100 and having those extracted topics associated with the user's profile on the social networking system 100. Similarly, a page administrator of a page on the social networking system 100 may also opt out of having topics associated with the page based on users' association with topics for ad targeting and other purposes.

### System Architecture

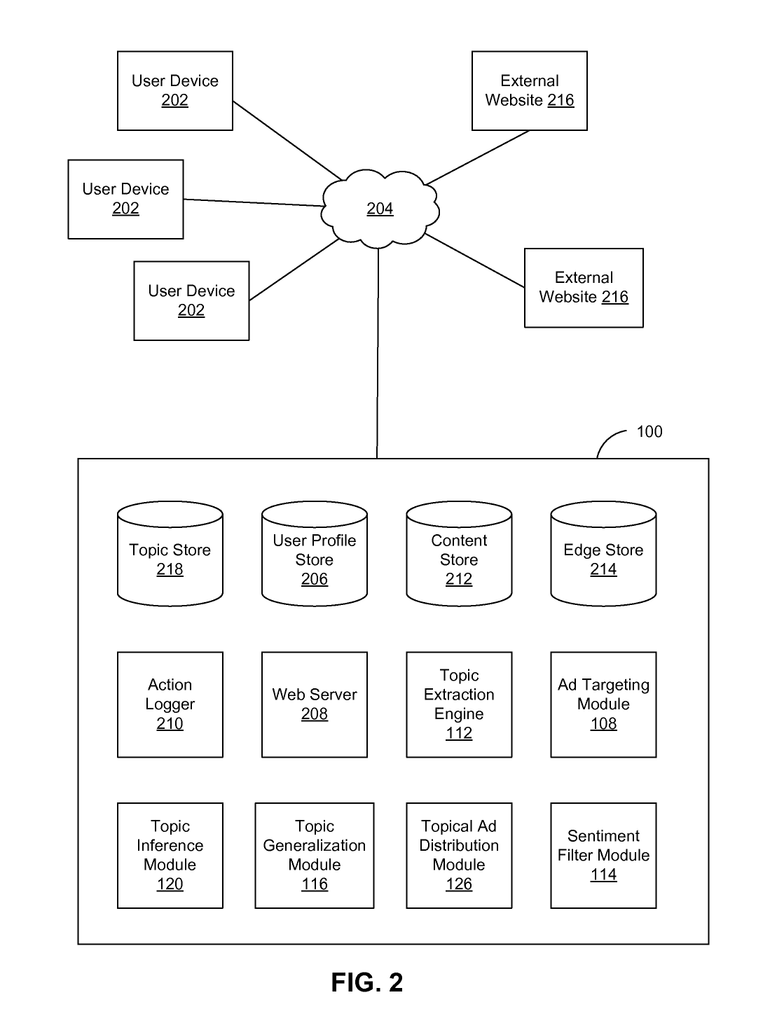

FIG. 2 is a high level block diagram illustrating a system environment suitable for inferring interests based on topics extracted from content items in a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a topic extraction engine 112, a sentiment filter module 114, a topic generalization module 116, an topic inference module 120, a topical ad distribution module 126, an ad targeting module 108, a web server 208, an action logger 210, a content store 212, an edge store 214, and a topic store 218. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

An ad targeting module 108 may receive targeting criteria for advertisements for display to users of a social networking system 100. The ad targeting module 108 provides advertisements to users of the social networking system 100 based on the targeting criteria of the advertisements. In one embodiment, topic targeting criteria 106 may be received for advertisements and processed by the ad targeting module 108. The topic extraction engine 112 continuously identifies and extracts topic objects 118 from content objects 110 generated on the social networking system that are relevant to the topic targeting criteria 106 received in the ad object 104. As a result, the ad targeting module 108 may target the advertisement to those content objects 110, such as directly attaching the advertisement to the relevant content objects 110, displaying the advertisement to users that have interacted with the relevant content objects 110, and so forth. In another embodiment, topic targeting criteria 106 may be inferred by the ad targeting module 108 based on the content of the advertisement. For example, an advertisement about “coffee,” based on a keyword analysis of the advertisement, may have topic targeting criteria 106 that includes a topic object 118 for “coffee,” “Starbucks Coffee,” and “Peet's Coffee.” In one embodiment, the topic generalization module 116 may help to infer topic targeting criteria 106.

An topic inference module 120 analyzes topic objects 118 extracted from content objects 110 by the topic extraction engine 112 to associate particular topic objects 118 with user profile objects 122 and page objects 124, in one embodiment. Using information about users of the social networking system 100 from user profile objects 122 retrieved from the user profile store 206, edge objects retrieved from the edge store 214, and information about objects retrieved content objects 110 and page objects 124 retrieved from the content store 212, the topic inference module 120 may associate particular topic objects 118 with user profile objects 122 and page objects 124. Machine learning algorithms may be used to determine these associations with the particular topic objects 118 based on past histories of users' interactions with content objects 110 associated with the particular topic objects 118. Additionally, machine learning algorithms may infer users' interest in a particular topic object 118 based on the information retrieved about the users and analysis of the real-time information about the users with respect to the particular topic object 118. As a result, the topic inference module 120 may identify associations between users and topics based on real-time analysis of content objects 110.

A topical ad distribution module 126 receives information about content objects 110 stored in the content store 212 of the social networking system 100, such as topic objects 118 that have been associated with the content objects 110, where the topic objects are stored in the topic store 218. A sentiment filter module 114 analyzes positive and negative sentiments expressed in content objects 110 stored in the content store 212 of the social networking system 100 to selectively associate topic objects 118 with content objects 110 that have positive sentiments about the topic objects 118.

Associating Topics with Users and Pages on a Social Networking System

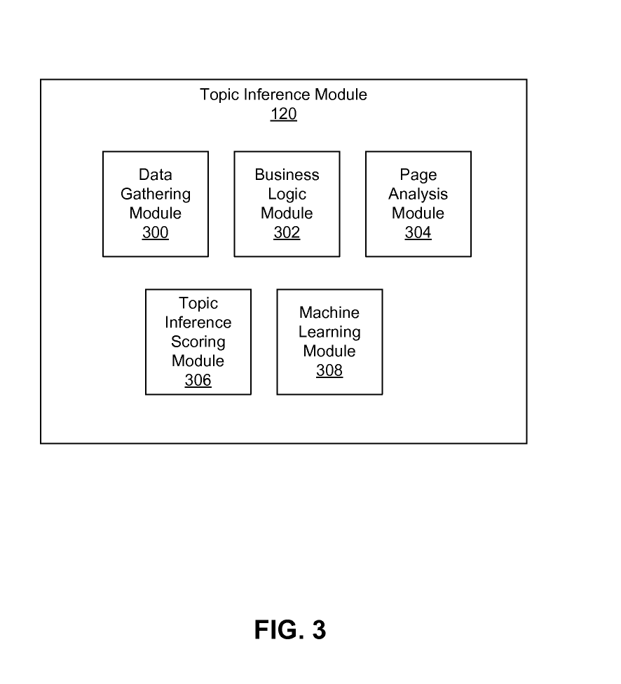

FIG. 3 illustrates a high level block diagram of the topic inference module 120 in further detail, in one embodiment. The topic inference module 120 includes a data gathering module 300, a business logic module 302, a page analysis module 304, a topic inference scoring module 306, and a machine learning module 308. These modules may perform in conjunction with each other or independently to infer topics from content objects for association with users and pages in a social networking system 100.

A data gathering module 300 retrieves information about users and pages on the social networking system 100 with respect to content objects 110 generated by the users and pages that are associated with topic objects 118, including information from user profile objects 122, edge objects, content objects 110, and page objects 124. The data gathering module 300 may retrieve user profile objects 122 that have been previously associated with a particular topic object 118 to determine whether those users should be further associated with a related topic object 118. For example, a user profile object 122 may include an association with a topic object 118 in the social networking system 100, such as a topic object 118 for the music artist Lady Gaga. The data gathering module 300 may also retrieve topic objects 118 associated with the object for Lady Gaga, such as topic objects 118 for pop music, electronic music, and dance music. Content objects 110 may be gathered by the data gathering module 300 that have been associated with the topic object 118 for Lady Gaga, such as a status update, comment, or photo upload.

In another embodiment, the data gathering module 300 may retrieve user profile objects 122 of other users connected to users that have been associated with a topic object 118. In yet another embodiment, user profile objects 122 may be retrieved by the data gathering module 300 based on users viewing one or more content object 110 associated with a particular topic object 118. For example, if an advertisement targeted the topic, “Lady Gaga” and if a viewing user listened to the song “Edge of Glory” by Lady Gaga using an external music streaming service, then the user profile object 122 for that user may be retrieved by the data gathering module 300 because the topic object 118 for Lady Gaga would be associated with the song object for “Edge of Glory.” The user may or may not be associated with the topic object 118 for Lady Gaga as a result of listening to the song. Thus, even if a user does not explicitly express an interest in Lady Gaga but has listened to a song by Lady Gaga, the user profile object 122 for that user may be retrieved by the data gathering module 300 in determining users to be associated with the topic object 118 representing Lady Gaga. Similarly, edge objects, content objects 110, and page objects 124 may be retrieved by the data gathering module 300 based on their association with the particular topic object 118 in determining whether the particular topic object 118 should be associated with a particular user profile object 122.

A business logic module 302 manages business logic rules received for inferring topics for association with pages and users of the social networking system 100. In one embodiment, the business logic module 302 receives one or more business logic rules used to determine whether a user or a page should be associated with a particular topic object 118. In one embodiment, the business logic module 302 may determine a user to be associated with a topic based on the user generating a predetermined threshold number of content objects 110 associated with the topic, such as a check-in event at a business, a listen action to a song, a photo upload, a status update mentioning a topic, and the like. In another embodiment, a user's affinity score for a topic object 118 may be used by the business logic module 302, in conjunction with predetermined threshold levels, to determine whether a user should be associated with the topic object 118. Other types of interactions may be used as factors with different weights in business logic rules, such as the user interacting with content objects 110 associated with a particular topic object 118 frequently over a given time period, installing applications associated with the topic object 118, and inviting other users connected to the user to engage with content objects 110 associated with the topic object 118. These factors and other types of interactions may be used by the business logic module 302 in determining whether a user or a page should be associated with a topic.

The business logic module 302 may be used in associating a topic with a user based on the user's interactions with a disparate set of content objects 110 based on a set of business logic rules. For example, a user may enter into a sweepstakes promotion hosted on a page on the social networking system. The user may install an application associated with the page object to enter the sweepstakes contest, and may then interact with other users on the page hosting the contest. Furthermore, the user may post frequent content items, such as status updates, wall posts on other users' profile pages, and comments on the content items, each represented by different content objects 110, that request other users to vote for the user in the sweepstakes contest. As a result, the user may influence other users to engage with the page hosting the contest, as well as install the application on the page in order to vote for the user. Business logic rules may be received by the business logic module 302, such as determining whether the user has interacted or generated content items associated with a particular topic with a frequency over a predetermined threshold. As a result, the user may be associated with the topic object 118 based on these interactions, in one embodiment. In another embodiment, the determination of whether the user is associated with the topic object 118 may be determined based on a number of factors, including the frequency of interactions with the page object and the quality of interactions, such as installing an application associated with the page object, uploading photos and other content to the page, inviting other users connected to the user to install the application, and so forth. Other factors that may be included in determining whether to associate the user with the topic may include whether the user was successful in influencing other users to engage with the page object, as well as whether the user was successful in influencing other users to engage with other objects in the past.

A business logic module 302 may receive different rules for associating a page with a topic on the social networking system 100. For example, a predetermined threshold number of users that are associated with a topic may be used in a business logic rule to determine that the page should be associated with the topic. In one embodiment, the threshold number may be a percentage. In another embodiment, a scoring algorithm may be used to that assigns weights to how strongly the topic is associated with each user. For example, a user that posts very frequently about Britney Spears in a positive sentiment may be strongly associated with the topic Britney Spears, whereas a user that listens to a few songs by Britney Spears over a defined time period may have a looser association with the same topic. In one embodiment, a user may have a topic association score generated by the topic inference scoring module 306 to reflect the strength of the association with a topic. Business logic rules may use topic association scores of users connected to a page in associating the topic with the page.

A page analysis module 304 determines an analysis of interactions by users associated with pages on the social networking system 100 for determining associations of the pages with topics. In one embodiment, an interaction history of each user associated with a page is analyzed by the page analysis module 304 to determine whether the page should be associated with a particular topic object 118. For example, a user's interactions with a page object 124 on the social networking system, such as a page for “Starbucks Coffee,” may be analyzed by the page analysis module 304. User interactions may include mentioning the page in a status update, photo upload, comment, or other content item posted to the social networking system 100. Other interactions may include installations of applications associated with the page, such as an external website associated with the page that manages a rewards program for Starbucks Coffee.

In one embodiment, a page object for “Starbucks Coffee” may be associated with open graph objects defined by a third-party developer, such as “latte” and “frappuccino” that a user may also interact with through open graph actions, such as “drinking” and “purchase.” As a result, interactions with these associated objects may also be analyzed by the page analysis module 304 and factored into determining an association of a page with a topic object 118, such as “Starbucks Coffee.”

A page analysis module 304 may also retrieve other user interactions that may be analyzed to infer an association between a page object 124 and a topic object 118. Aside from direct user interactions with a page, other user interactions on the social networking system 100 and external to the social networking system 100 may be used in determining topic association scores for the users connected to the page. For example, a user connected to the page may generate comments, status updates, and other content items on the social networking system 100 that are not directly connected to the page, but are associated with one or more topic objects 118 relevant to the particular topic object 118 being analyzed by the page analysis module 304.

A topic inference scoring module 306 may generate one or more topic inference models for associating pages and users with topic objects 118. Topic inference models may include a number of user-specific factors, including a user's past engagement history with other topic objects related to the particular topic object 118, behavior patterns of the user with respect to usage on the social networking system 100, the number of other users connected to the user associated with the particular topic object 118, and other characteristics of the user, such as demographics, location, and keyword information extracted from a user profile associated with the user, in one embodiment. The user's characteristics may be useful in filtering topics based on relevance to demographics, location, and/or keyword information extracted from the user's profile. For example, a young person may not be associated with the topic object 118 for “AARP.”

A topic inference scoring module 306 may be used to determine topic association scores for users and pages of the social networking system 100 based on a model for associating the users and pages with topics. Topic association scores may be determined based on whether users and/or pages exhibit features in a model for associating the topic object 118 with the users and/or pages. As a user or a page exhibits more features in the model for the topic object, an topic association score for that user or page increases. In one embodiment, a model for a topic includes features that are unique to the topic. For example, the San Francisco Giants may have unique features in the model for inferring topic association for users versus another Major League Baseball team, such as the Los Angeles Dodgers because the San Francisco Giants have been having record attendance, selling out most games, and have unique players and themes such as panda hats and beards. As a result, a user that may mention that they are attending a San Francisco Giants game in a comment, status update, or content item may have a lower topic association score than another fan that attends games regularly, posts status updates and comments frequently, and has photos of the user in a beard or with a panda hat. Conversely, a user that attends a Los Angeles Dodgers game may have a higher topic association score than a user attending a Giants game simply because of the past history of poor attendance of Dodgers fans as indicated on the social networking system 100. Because there is generally more interest in the Giants, a model scoring topic association inferences for the Giants may rely on additional features, such as frequency of mentioning Giants in content items, groups joined on the social networking system associated with the Giants, applications installed on the social networking system associated with the Giants, and check-in events near a place or venue associated with the Giants.

Other features used by the topic inference scoring module 306 in models for scoring topic association inferences may include features such as retrieving user-specific information, including content items associated with the specified topic objects, keywords related to the specified topic objects extracted from content items posted by users, and whether users are connected to other users that are associated with the specified topic objects. Models may use weighted factors, regression analysis, and/or other statistical techniques to determine topic association scores.

A machine learning module 308 is used in the topic inference module 120 to select features for models generated for inferring topic associations for pages and users in the social networking system 100. In one embodiment, a social networking system 100 uses a machine learning algorithm to analyze features of a model for scoring topic associations of users for a specified object. The machine learning module 308 may select user characteristics as features for the model for inferring topic associations for a topic, such as past user engagement with the object, previously determined affinity scores for the topic, and whether other users connected to a user have been associated with the topic using at least one machine learning algorithm. In another embodiment, a machine learning algorithm may be used to optimize the selected features for the model based on conversion rates of advertisements targeted to users using the topical ad distribution module 126. A selected feature may be removed based on a lack of engagement by users that exhibit the selected feature. For example, a selected feature for a model for inferring topic associations for a topic object for “coffee” may include a high affinity score for Starbucks Coffee based on numerous check-in events at Starbucks Coffee locations. However, suppose users exhibiting a high confidence score for checking into a Starbucks Coffee location in the next week based on numerous check-in events at Starbucks Coffee locations do not engage with the advertisement in expected numbers. The machine learning algorithm may deselect that feature, the numerous check-in events, in the model for determining topic association scores of users for “coffee,” in one embodiment. In another embodiment, the topic association scores may be reduced by decreasing the weight placed on the check-in events at Starbucks Coffee locations. Performance metrics of advertisements, such as whether a user engaged with the advertisement, may be used in this way to train the machine learning algorithm to select, deselect, or modify weights of features in the model.

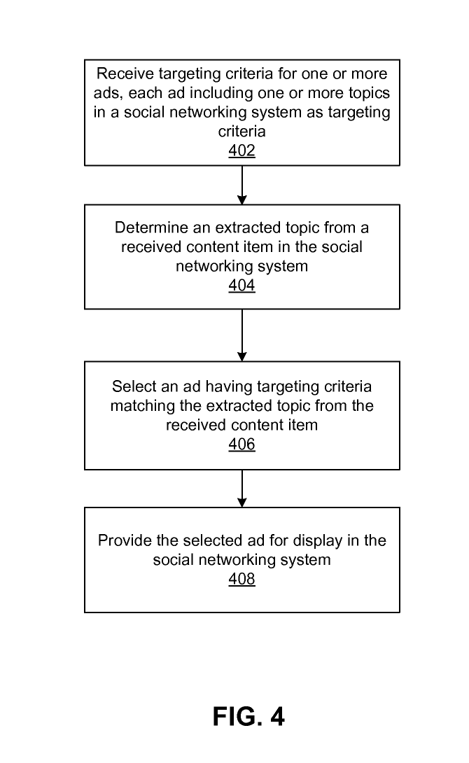

FIG. 4 illustrates a flow chart diagram depicting a process of targeting advertisements to users of a social networking system based on extracted topics from content items in the social networking system, in accordance with an embodiment of the invention. A social networking system 100 receives 402 targeting criteria for one or more ads, each ad including one or more topics in the social networking system as targeting criteria. The topic specified in the targeting criteria represents a topic object 118 in the social networking system 100, such as a brand, celebrity, news headline, a cause, and so forth.

An extracted topic is determined 404 from a received content item in the social networking system. Topics may be extracted from content items by a topic extraction engine 112 upon receiving content items from users, entities, pages, and/or applications. For example, a status message update may include the name of an artist, such as Picasso. The extracted topic of “Picasso” may be determined 404 from the status message update. Other types of content items and user interactions, including page likes, page posts, video uploads, check-in events, application installations, and application updates made on behalf of users may also have extracted topics determined 404. In one embodiment, an extracted topic is determined 404 based on a user's page likes, or connections to pages in the social networking system 100. A page may be associated with a particular topic by the social networking system or by a page administrator. Based on the user's page likes and interactions with pages, an extracted topic may be determined 404.

After an extracted topic is determined 404 from a received content item in the social networking system, the social networking system selects 406 an ad having targeting criteria matching the extracted topic from the received content item. For example, an extracted topic of “Picasso” may match targeting criteria of an advertisement by a local museum for an upcoming Picasso exhibit. As a result, that advertisement may be selected 406 by the social networking system 100.

The selected ad is then provided 408 for display in the social networking system. In one embodiment, the selected ad is provided 408 for display as an attachment to the content item from which the extracted topic was determined 404. Returning to the example, the status message update that included a mention of “Picasso” may be targeted for an advertisement having targeting criteria for the “Picasso” topic. The social networking system 100 may provide 408 the selected ad for display by attaching the selected ad to the status message update for viewing users of the social networking system 100, for example. In another embodiment, the selected ad may be provided 408 for display in the social networking system 100 through other methods, such as a banner ad on a page in the social networking system 100, a banner ad on the page where the status message update is displayed, a sponsored story highlighted in a news feed on the social networking system 100, a mobile advertisement, and the like.

In yet another embodiment, the selected ad may be provided 408 for display in the social networking system 100 as a social advertisement, or social endorsement on the social networking system 100. A social advertisement gathers stories about a topic. For example, a social advertisement for a Hawaii vacation package may target users that have mentioned the topic of “Hawaii” in the past few days. The social advertisement may aggregate content items generated by a viewing user's connections on the social networking system 100 that mention the topic of “Hawaii,” such as “Paul Smith and 3 of your friends are talking about Hawaii” and append the aggregated content items, or stories. In this way, the social advertisement has brought to the attention of the viewing user that friends are talking about Hawaii. In one embodiment, a call to action, such as an invitation to click on a link, may be appended to the social advertisement, such as “Grab a deal on Hawaii vacation package today!”

In a further embodiment, the selected ad may be provided 408 for display in the social networking system 100 as a sponsored story. An advertiser may desire to increase brand awareness and purchase an advertisement having targeting criteria that includes a topic closely tied to the advertiser's brand. For example, an advertiser for Justin Bieber may target user generated content items about the topic of Justin Bieber's newest single, “Boyfriend.” Because the term “boyfriend” may refer to the generic meaning, the topic extraction engine 112 would need to determine that the content item is specifically referring to the Justin Bieber song and not the generic meaning of “Boyfriend.” The advertiser may desire to sponsor a story generated by a user of the social networking system 100, such as a story indicating that a user listened to Justin Bieber's single “Boyfriend” using a streaming music application. This story may be boosted in priority of display on the social networking system's communication channels, such as a news feed displayed on a mobile device, sponsored story ad placement on a web page displayed on a browser, or as a separate content item displayed on an application operating on a user device. As a result, the selected ad, in this case the sponsored story, is provided 408 for display in the social networking system 100.

In other embodiments, topical advertisements may be distributed in other ways. For example, targeting clusters of users may be determined based on the topic association scores generated for the users for a particular topic. Topical advertisements may then be distributed for display to the targeting clusters of users based on the topic association scores of the users at the time they may be potentially viewing the advertisements. In one embodiment, topic association scores may include a time decay factor such that recent interactions with a topic are assigned more value than older interactions. In another embodiment, topic association scores may include a factor that accounts for the number of connections of the user that are also associated with the topic compared to the total number of connections the user has on the social networking system.

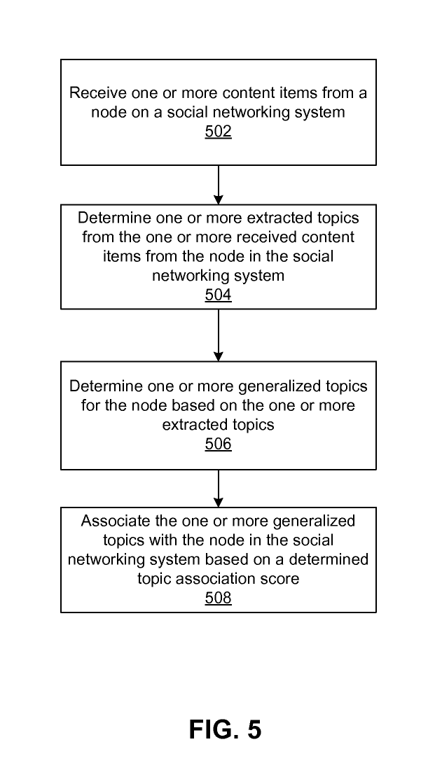

FIG. 5 illustrates a flowchart of a process of associating one or more generalized topics with a node in a social networking system, in accordance with an embodiment of the invention. One or more content items are received 502 from a node on a social networking system. A node may include a user, an entity, an application, or a user acting on behalf of a page in the social networking system 100, in one embodiment. One or more content items may be received 502 from a node via a communication channel, such as a status update message, a photo or video upload, a check-in event, a post on a page, and the like.

After one or more content items have been received 502 from a node in the social networking system, one or more extracted topics are determined 504 from the one or more content items received from the node. Topics may be extracted from content items by a topic extraction engine 112. Topics may also be determined 504 for a node, such as a page or an application, based on topics previously associated with users that are connected to the node, in one embodiment. The users may have been previously associated with topics based on topics extracted from content items generated by or interacted with by the users connected to the node.

Once the one or more extracted topics from the one or more content items received from the node have been determined 504, one or more generalized topics for the node may be determined 506 based on the one or more extracted topics. Generalized topics may be determined 506 from the extracted topics using the topic generalization module 116, in one embodiment. In another embodiment, generalized topics may be determined 506 from the extracted topics using category trees, dictionaries, databases, and the like.

After the one or more generalized topics for the node are determined 506 based on the one or more extracted topics, the one or more generalized topics are associated 508 with the node based on a determined topic association score. A topic association score may be determined using the topic inference module 120, in one embodiment. In another embodiment, a topic association score for associating the one or more generalized topics with the node may be determined using the topic generalization module 116. The one or more generalized topics are associated 508 with the node based on the determined topic association score meeting a predetermined threshold value, in one embodiment. In another embodiment, the one or more generalized topics may be associated 508 with the node based on one or more business logic rules using the determined topic association score.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a plurality of user profile objects on a social networking system, the plurality of user profile objects representing a plurality of users of the social networking system;
receiving an advertisement request for an advertisement having targeting criteria identifying a targeted topic in the social networking system;
determining a plurality of content objects in the social networking system associated with a subset of the plurality of users, where the plurality of content objects are associated with the targeted topic identified in the targeting criteria of the advertisement;
retrieving the plurality of content objects associated with the targeted topic identified in the targeting criteria of the advertisement;
determining a plurality of topic association scores for the subset of the plurality of users associated with the plurality of content objects;
determining a targeting cluster of users for the advertisement based on the plurality of topic association scores of the subset of the plurality of users of the social networking system associated with the plurality of content objects; and
for a viewing user of the social networking system in the targeting cluster of users, providing the advertisement for display to the viewing user based on a topic association score of the viewing user for the targeted topic.

2. The method of claim 1, wherein determining a plurality of topic association scores for the subset of the plurality of users associated with the plurality of content objects further comprises:
for each user of the subset of the plurality of users associated with the plurality of content objects, determining a topic association score based on a user interaction history for the user and the plurality of content objects associated with the targeted topic.

3. The method of claim 1, wherein determining a plurality of topic association scores for the subset of the plurality of users associated with the plurality of content objects further comprises:
for each user of the subset of the plurality of users associated with the plurality of content objects, retrieving an affinity score of the user with respect to the targeted topic; and
determining a topic association score for each user of the subset of the plurality of users associated with the plurality of content objects based on the affinity score of the user with respect to the targeted topic included in the targeting criteria of the advertisement.

4. The method of claim 1, wherein determining a plurality of content objects associated with the targeted topic further comprises:
for each content object,
extracting one or more topics in the social networking system embodied in the content object; and
associating the targeted topic with the content object based on a category tree comprising the targeted topic and the one or more extracted topics.

5. The method of claim 1, wherein determining a plurality of content objects associated with the targeted topic further comprises:
for each content object,
extracting one or more topics in the social networking system embodied in the content object; and
associating the targeted topic with the content object based on a dictionary comprising the targeted topic and the one or more extracted topics.

6. The method of claim 1, wherein determining a plurality of content objects associated with the targeted topic further comprises:
for each content object,
extracting one or more topics in the social networking system embodied in the content object; and
associating the targeted topic with the content object based on a database comprising the targeted topic and the one or more extracted topics.

7. A method comprising:
maintaining a plurality of user profile objects on a social networking system, the plurality of user profile objects representing a plurality of users of the social networking system, the plurality of users comprising a viewing user;
receiving interactions with one or more content objects from the viewing user;
extracting one or more topic objects for the content objects, where each extracted topic object is based on a topic associated with at least one of the content objects;
selecting an advertisement to provide to the viewing user based at least in part on the one or more extracted topics; and
providing the selected advertisement for display to the viewing user.

8. The method of claim 7, wherein the content object is generated based on a graph action performed on a graph object on an external system, the graph action and the graph object defined by an entity external to the social networking system.

9. The method of claim 7, wherein selecting the advertisement to provide to the viewing user is further based on applying targeting criteria for the advertisement to the one or more extracted topics for the viewing user.

10. The method of claim 7, wherein the selected advertisement comprises a story selected based on the one or more extracted topics.

11. The method of claim 7, wherein the selected advertisement is presented with a story selected based on the one or more extracted topics.

12. The method of claim 7, wherein providing the selected advertisement for display to the viewing user further comprises:
providing the selected advertisement for display appended to a story related to the one or more extracted topics displayed on the social networking system.

13. The method of claim 7, wherein providing the selected advertisement for display to the viewing user further comprises:
providing the selected advertisement for display to the viewing user as a social endorsement related to the one or more extracted topics on the social networking system.

14. The method of claim 7, wherein providing the selected advertisement for display to the viewing user further comprises:
providing the selected advertisement for display to the viewing user as a banner advertisement on a web page provided on the social networking system.

15. The method of claim 7, wherein providing the selected advertisement for display to the viewing user further comprises:
providing the selected advertisement for display to the viewing user as a sponsored story in the social networking system.

16. The method of claim 7, wherein providing the selected advertisement for display to the viewing user further comprises:
providing the selected advertisement for display to the viewing user as a mobile advertisement on a user device.

17. The method of claim 7, wherein an interaction of the received interactions from the viewing user comprises a comment action performed on a content item in the social networking system.

18. The method of claim 7, wherein an interaction of the received interactions from the viewing user comprises a post action performed on a content item in the social networking system.

19. The method of claim 7, wherein an interaction of the received interactions from the viewing user comprises a share action performed on a content item in the social networking system.

20. The method of claim 7, wherein an interaction of the received interactions from the viewing user comprises a like action performed on a content item in the social networking system.

21. The method of claim 7, wherein an interaction of the received interactions from the viewing user comprises a like action performed on a page in the social networking system.

22. A method comprising:
receiving targeting criteria for an advertisement on a social networking system, where the targeting criteria identifies a targeted topic in the social networking system;
determining a plurality of content items associated with a viewing user of the social networking system, the plurality of content items referring to the targeted topic;
selecting the advertisement for display to the viewing user based at least in part on a connection between the viewing user and the content item of the plurality of content items referring to the targeted topic; and
sending the selected advertisement for display to the viewing user.

23. The method of claim 22, wherein determining a plurality of content items associated with a viewing user of the social networking system, the plurality of content items referring to the targeted topic further comprises:
determining identifying information of users of the social networking system that are associated with the targeted topic.
